(19) United States
(12) Patent Application Publication
(10) Pub. No.: US 2024/0176821 A1
(43) Pub. Date: May 30, 2024

(54) Targeted Content Delivery Within A Web Platform

(71) Applicant: Indeed, Inc., Austin, TX (US)

(72) Inventors: Li Ji, Santa Clara, CA (US); Haiyan Luo, Santa Clara, CA (US); Yu Sun, Santa Clara, CA (US)

(21) Appl. No.: 18/072,582

(22) Filed: Nov. 30, 2022

(51) Int. Cl. G06F 16/903; G06F 16/9035; G06F 16/908; G06N 5/02

(52) U.S. Cl. CPC G06F 16/90335; G06F 16/9035; G06F 16/908; G06N 5/02

(57) ABSTRACT

A knowledge graph embedding-based approach to content labeling is used for targeted content delivery in a web platform, such as a job website. Job posting data of the web platform is normalized and used to train a knowledge graph embedding. Labels are determined for job posting data of the web platform using the trained knowledge graph embedding, and mappings are determined between the labels and segments of users of the web platform. Current user data is obtained for a user of the web platform. A current segment to which the user corresponds is determined based on the current user data, a current mapping to which the current segment corresponds is determined based on the current segment, and targeted content to deliver to a device of the user is determined according to the current mapping. The targeted content may then be delivered to the user device.

### BACKGROUND

Job websites are effective and increasingly popular platforms for connecting skilled job seekers and job posters in need of support. A job poster may use a job website or a third party system interfacing with the job website to create a job posting for a specific type of work, and job seekers matching criteria listed in the job posting may interact with the job posting to pursue a new work opportunity. Similarly, a job seeker may use a job website to upload resumes and other documentation representing their skills and relevant background information to attract desirable job posters.

### SUMMARY

Disclosed herein are, inter alia, implementations of systems and techniques for targeted content delivery within a web platform.

One aspect of this disclosure is a method, which includes: normalizing historical job posting data of the web platform to produce normalized job title data and normalized query data; training, using unsupervised learning, a knowledge graph embedding to identify relationships between segments of users of the web platform and nodes representative of portions of one or both of the normalized job title data and the normalized query data within a knowledge graph of the web platform; determining labels for the historical job posting data of the web platform based on the relationships identified using the trained knowledge graph embedding; obtaining a query from a user device of a user of the web platform; determining a segment of the segments to which the user corresponds based on the query; determining that the segment is associated with a label of the labels; determining targeted content to deliver to the user device in response to the query based on the label; and causing a delivery of the targeted content to the user device.

Another aspect of this disclosure is a method, which includes: determining, using a knowledge graph embedding trained using normalized job data of the web platform, mappings between segments of users of the web platform and labels for the normalized job data; obtaining current user data for a user of the web platform from a user device of the user; determining, based on the current user data, a current segment of the segments to which the user corresponds; determining, according to a current mapping of the mappings, a current label of the labels to which the current segment corresponds; and causing a delivery of targeted content associated with the current label to the user device.

Yet another aspect of this disclosure is a method, which includes: training a knowledge graph embedding to identify relationships between items of normalized job data of the web platform across one or more dimensions; determining mappings between segments of users of the web platform and labels for job posting data of the web platform using the trained knowledge graph embedding; determining, based on current user data for a user of the web platform obtained from a user device of the user, a label of the labels using a mapping of the mappings between the label and a segment of the segments; and causing a delivery of targeted content associated with the label to the user device.

### BRIEF DESCRIPTION OF THE DRAWINGS

This disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a block diagram of an example of a web platform system.

FIG. 2 is a block diagram of an example of a computing device used with a web platform system.

FIG. 3 is a block diagram of an example of a web platform that hosts job postings.

FIG. 4 is a block diagram of an example of a system for targeted content delivery within a web platform.

FIG. 5 is a block diagram of an example of embedding and label production functionality of a system for targeted content delivery within a web platform.

FIG. 6 is a block diagram of an example of label selection functionality of a system for targeted content delivery within a web platform.

FIG. 7 is a flowchart of an example of a technique for mapping content of a web platform to labels for targeted content delivery.

FIG. 8 is a flowchart of an example of a technique for targeted content delivery within a web platform.

### DETAILED DESCRIPTION

A job seeker may access a job website to search for job postings of interest to them. The job website could be a web service such as Indeed, ZipRecruiter, LinkedIn, CareerBuilder, and similar. For example, a job seeker visiting Indeed.com may be presented with an option to search for job postings by entering search criteria covering fields such as job title, keyword, and/or company within a given location (e.g., city and state). The job website identifies some number of job postings matching, or otherwise within some threshold similarity to, the search criteria entered by the job seeker and presents those job postings to the job seeker in a consumable format as search results. For example, the search results may be sorted by relevance to the search criteria or by the date on which job postings within the search results were published at the job website. The job seeker may then review the job postings within the search results and, as applicable, begin the process to apply to one or more of them.

Many job postings are filled simply by job seekers manually searching on a job website. However, some job postings, such as those for which urgent fulfillment is desirable or for which there may be a relatively limited pool of qualified candidates, may benefit from campaigns designed to facilitate their fulfillment. To facilitate job posting fulfillment, a job website may serve, or cause to be served, select job postings as targeted content (e.g., advertisements) for consumption by a job seeker. Generally, a job posting comprising the targeted content may be delivered as a search ad or a display ad. With search ads, a job posting or information associated therewith is delivered as the targeted content in response to a search for certain types of job postings on a job website as described above. With display ads, a job posting or information associated therewith is delivered as the targeted content within some message prompted or otherwise presented to a job seeker within the job website, typically without a job search being involved or required.

Targeted content approaches such as those involving the delivery of search ads and display ads thus operate to serve information about select job postings to potential job seeker candidates. That is, the delivery of certain job posting information to a job seeker who may not have otherwise accessed such job posting information may facilitate a fulfillment of the subject job posting. Still, not all job postings are relevant to all job seekers, and so such approaches rely upon targeting rules for controlling the delivery of select job posting content to select job seekers. Typically, targeting rules for content delivery are manually defined to connect certain types of keywords or user information to certain categories of content, with the goal of recognizing certain content consumers as being within select audience segments and certain categories of content as being relevant to select audience segments.

Defining and asserting such targeting rules requires that a human manually associate content with a label usable to identify the content as relevant to a consumer and that the label be accurate for the content. However, this manual process is subject to several drawbacks. In particular, a person performing this manual process may be inexperienced and resultingly introduce errors (e.g., by failing to recognize a misuse of a label or by using a suboptimal label where a better option is available) rendering the targeting rules inadequate. Furthermore, while inadequate targeting rules may still be moderately effective in certain scenarios in which content rarely changes over time, they are generally ineffective in scenarios in which content is often subject to change. In particular, because the corpus of job postings hosted by a job website may frequently change (e.g., due to changes in employment market conditions, the introduction of new types of jobs not previously represented within the corpus, or the elimination of types of jobs that no longer exist in the marketplace), the inadequate labeling of job posting content as being relevant to a given audience segment may result in irrelevant job postings being delivered to job seekers. The delivery of an irrelevant job posting to a job seeker will very rarely result in the job posting being filled by that job seeker.

Implementations of this disclosure accordingly address problems such as those described above by using a knowledge graph embedding-based approach for mapping content of a web platform, such as a job website, to labels for targeted content delivery and performing or otherwise facilitating targeted content delivery within the web platform. A knowledge graph embedding is trained based on normalized job titles and normalized queries, in which the normalized job titles are determined based on job titles of a job posting corpus of the web platform and the normalized queries are determined based on queries input by job seekers to search for job postings within the web platform.

As used herein, normalization refers to the process for converting raw job data (i.e., job titles or queries received as input from a user of the web platform) that have more than one possible expression into one of a known set of normalized job titles and queries. As such, a normalized job title is a job title that represents varied expressions of multiple related job titles within job postings hosted by the web platform, such that any of those related job title expressions would be classified to the one normalized job title. Similarly, a normalized query is a query that represents varied expressions of multiple related queries received as input from users searching for job postings within the web platform, such that any of those related query expressions would be classified to the one normalized query. The normalized job titles and normalized queries determined based on the job posting information of the web platform may thus serve as standardized terms used to classify the varied expressions of job titles and queries received from users of the web platform for further processing.

In some implementations, the trained knowledge graph embedding represents triplets of a knowledge graph. The triplets are each embedded based on a normalized job title or a normalized query to determine labels, which are then stored in a label definition data store. The labels are determined to associate job postings later processed using them with certain types of queries so that a job seeker from whom a query is received view the web platform may be served with targeted content (i.e., a job posting or information associated therewith) relevant to the job seeker (e.g., relevant to information associated with a resume or skill set of the job seeker or to the query input by the job seeker).

The labels are added to one or more data structures, such as vectors, and indexed according to different entity types with which the labels may be associated (e.g., based on whether the labels are determined based on embeddings from normalized job titles or embeddings from normalized queries). When a job posting to be labeled is received, the labels are retrieved from the label definition data store by calling the indices of the data structures. The retrieved labels are then evaluated against a normalized job title associated with the job posting to score the indices for the labels. Labels for which indices are scored above a threshold are then added to a list of recommended labels, which may be sorted in order of those scores. One or more labels from the list of recommended labels may then be assigned to the job posting. Thus, when a job seeker later enters a query into the web platform, the query may be processed similarly to map one or more labels thereto, and a job posting corresponding to those same one or more labels may then be delivered as targeted content, such as within the web platform.

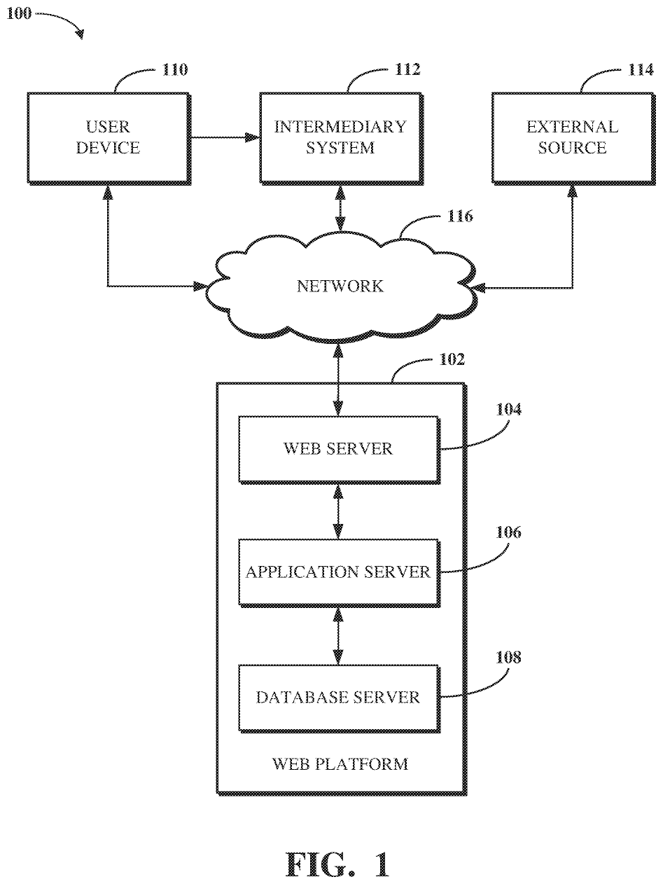

To describe some implementations in greater detail, reference is first made to examples of hardware and software structures used to implement a system for targeted content delivery within a web platform and/or for mapping content of a web platform to labels for targeted content delivery. FIG. 1 is a block diagram of an example of a web platform system 100, which includes a web platform 102. The web platform 102 implements a job website for enabling job seeking users to upload credential details and search for job opportunities via job postings and for enabling job posting users to create and manage job postings and view engagement information associated with job seekers who have viewed and engaged with such job postings. The web platform 102 implements the job website using one or more servers, including a web server 104, an application server 106, and a database server 108. For example, the web server 104, the application server 106, and the database server 108 may be implemented by one or more servers or server racks located within one or more datacenters. A user of the web platform 102 may access the web platform 102 via a user device 110, which may, for example, be a mobile phone, a tablet computer, a laptop computer, a notebook computer, a desktop computer, or another suitable computing device or combination of computing devices.

The web server 104 processes requests (e.g., hypertext transport protocol (HTTP)-based requests) received from user devices, such as the user device 110, destined for a software service associated with the web platform 102. In particular, the web server 104 operates as a conduit to content of the web platform 102 to be served to the user device 110 in response to requests received therefrom. The content derives from the application server 106 and is routed via the web server 104 to the user device 110 for rendering at the user device 110, for example, within a web browser or other software application running at the user device.

The application server 106 runs one or more software services associated with the web platform 102 which may be delivered to the user device 110 based on requests processed via the web server 104. For example, the application server 106 may implement a web application for the job website of the web platform 102. The application server 106 can include one or more application nodes, which can each be a process executed on the application server 106 to deliver software services to the user device 110, as part of the web platform 102. An application node can be implemented using processing threads, virtual machine instantiations, or other computing features of the application server 106. In some cases where the application server 106 can includes two or more application nodes forming a node cluster, those application nodes, while implemented on a single application server 106, can run on a single hardware server or different hardware servers.

The database server 108 manages (e.g., stores or otherwise provides) data usable to deliver software services implemented by the application server 106 to the user device 110. The database server 108 may implement one or more databases, tables, or other information sources suitable for use with such a software service. The database server 108 may include a data storage unit accessible by software executed on the application server 106. A database implemented by the database server 108 may, for example, be a relational database management system, an object database, an extensible markup language (XML) database, one or more flat files, other suitable non-transient storage mechanisms, or a combination thereof. In some cases, one or more databases, tables, other suitable information sources, or portions or combinations thereof may be stored, managed, or otherwise provided by a component other than the database server 110, for example, the user device 110 or the application server 106.

In some cases, some or all of the information usable to create a job posting at the web platform 102 may derive other than from the user device 110. For example, such information may derive from one or both of an intermediary system 112 or an external source 114, such as in addition to or instead of from the user device 110.

The intermediary system 112 is software usable to route information usable to create a job posting to one or more web platforms including the web platform 102. For example, the intermediary system 112 may be an applicant tracking system (ATS). A user of an ATS may, for example, cause information associated with a job posting to be created from the ATS to each of the multiple web platforms, such as to attempt to reach a wider pool of potential job seeker candidates using different ones of those web platforms. The intermediary system 112 may obtain the information associated with the job posting directly from a user, such as via the user device 110. For example, the user device 110 may connect to a server of the intermediary system 112 to transmit text and/or other materials associated with the job posting to be created, and the intermediary system 112 may then accordingly route such obtained text and/or other materials to the multiple web platforms.

The external source 114 is an electronic communication component configured to store information in one or more contexts. For example, the external source 114 may be an online social media platform, a cloud storage system, a company website associated with the user of the user device 110, or another website or software service that at one or more times obtained and stored information which may be relevant to otherwise associated with a job posting to be created. The external source 114 may, for example, transmit such information to the web platform 102 based on a request from the web platform 102 or the user device 110 made over an application programming interface (API) call.

The user device 110, the intermediary system 112, and the external source 114 each communicates with the servers 104 through 108 of the web platform 102 via a network 116. The network 116 can be or include the Internet, a local area network (LAN), a wide area network (WAN), a virtual private network (VPN), or another public or private means of electronic computer communication capable of transferring data between devices. The network 116, or another element, or combination of elements, of the system 100 can include network hardware such as routers, switches, other network devices, or combinations thereof. For example, a datacenter at which one or more of the servers 104 through 108 are located can include a load balancer for routing traffic from the network 116 to ones of those servers at the datacenter. The load balancer can route, or direct, computing communications traffic, such as signals or messages, to respective elements of the datacenter. For example, the load balancer can operate as a proxy, or reverse proxy, for a service associated with the web platform 102 or another service provided to the user device 110, by the web server 104, the application server 106, and/or another server. Routing functions of the load balancer can be configured directly or via a DNS. In some implementations, the load balancer can operate as a firewall, allowing or preventing communications based on configuration settings.

As will be described below in further detail, the web platform system 100 in relevant part performs targeted content delivery within the web platform 102, such as to determine mappings between content of the web platform 102 and labels for such content and to cause a delivery of items of such content to user devices connected to the web platform 102 (e.g., the user device 110) based on user data of the users of those user devices. In particular, the system 100 may include functionality for targeted content delivery within the web platform 102, in which a knowledge graph embedding is trained based on normalized job titles and normalized queries for a job posting corpus of the web platform 102 to determine labels for job postings hosted by the web platform 102, and in which those ones of those labels are later associated with (e.g., applied to, tagged to, or indicated as corresponding to) select job postings currently in the job posting corpus and which may be later added thereto. The labels associated with a given job posting are used to identify the job posting as targeted content to deliver to a job seeker in response to a search for job postings by the job seeker at the web platform 102.

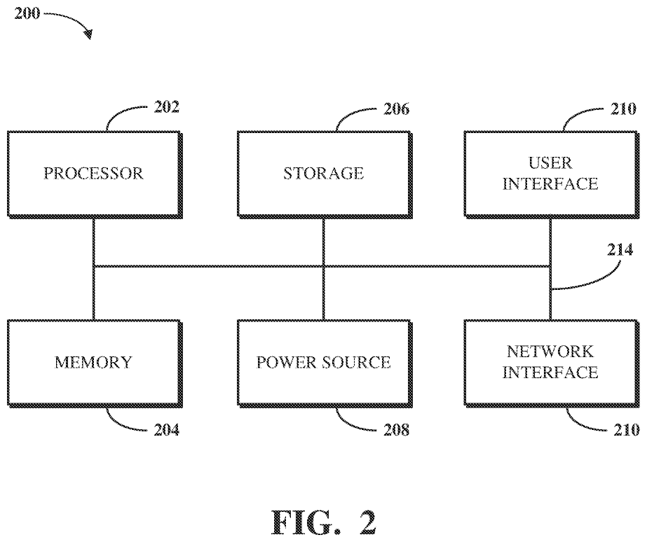

FIG. 2 is a block diagram of an example of a computing device 200 used with a web platform system, for example, the web platform system 100 shown in FIG. 1. The computing device 200 may, for example, be or be used to implement one or more of the web server 104, the application server 106, the database server 108, or the user device 110, all as shown in FIG. 1. The computing device 200 includes a processor 202, a memory 204, a storage 206, a power source 208, a user interface 210, and a network interface 212, all connected via a bus 214.

The processor 202 is a central processing unit, such as a microprocessor, having one or more processing cores. In some cases, the processor 202 can include another type of device, or multiple devices of one or more types, configured for manipulating or processing information. For example, operations performed by the processor 202 can be distributed across multiple devices that can be coupled directly (e.g., via a hardwired connection) or across a local area or other suitable type of network (e.g., via a networked connection). The processor 202 can include a cache for local storage of operating data or instructions.

The memory 204 includes one or more volatile memory components, such as random access memory (RAM), for example, static RAM (SRAM) and/or dynamic RAM (DRAM). In some cases, the memory 204 can represent a portion of memory distributed across multiple devices. In such a case, the memory 204 can include network-based memory or memory in multiple computing devices (e.g., in client-server or other arrangements) performing the operations of those multiple computing devices. The memory 204 includes operating data or instructions for immediate access by the processor 202. In one example, the memory 204 can include executable instructions corresponding to one or more application programs, which instructions can be loaded or copied, in whole or in part, from the storage 206 to the memory 204 to be executed by the processor 202, such as for performing some or all of the techniques of this disclosure. In another example, the memory 204 can include application data, such as user data, database data, functional program data, or the like. In yet another example, the memory 204 can include an operating system, for example, Microsoft Windows®, Mac OS X®, or Linux®, an operating system for a mobile device (e.g., a smartphone or tablet device), or an operating system for a non-mobile device (e.g., a mainframe computer).

The storage 206 includes one or more non-volatile memory components, such as a disk drive, a solid state drive, flash memory, or phase-change memory. The storage 206 stores operating data or instructions to be loaded or copied, in whole or in part, into the memory 204 to be executed by the processor 202. In some cases, the storage 206 can represent a portion of storage distributed across multiple devices. In such a case, the storage 206 can include network-based storage or storage in multiple computing devices (e.g., in client-server or other arrangements) performing the operations of those multiple computing devices.

The power source 208 delivers power to other components of the computing device 200. The power source 208 may, for example, be an interface (e.g., a power cable port) to an external power distribution system or a battery. In some cases, the power source 208 may include multiple power sources. For example, one of the multiple power sources can be a backup battery.

The user interface 210 includes one or more input interfaces and/or one or more output interfaces. An input interface may, for example, be a positional input device (e.g., a mouse, touchpad, or touchscreen), a keyboard, an audio input device (e.g., a microphone), or another suitable human or machine interface device. An output interface may, for example, be a display (e.g., a liquid crystal display, a cathode-ray tube, a light emitting diode display, or another suitable display) an audio output device (e.g., a speaker), or another suitable human or machine interface device.

The network interface 212 includes a wired network interface or a wireless network interface for interfacing with (i.e., connecting to) a network (e.g., the network 116 shown in FIG. 1). The network interface 212 enables the computing device 200 to communicate with other devices using one or more network protocols, for example, ethernet, transmission control protocol (TCP), internet protocol (IP), power line communication, an IEEE 802.X protocol (e.g., Wi-Fi, Bluetooth, or ZigBee), general packet radio service (GPRS), global system for mobile communications (GSM), code-division multiple access (CDMA), Z-Wave, another protocol, or a combination thereof.

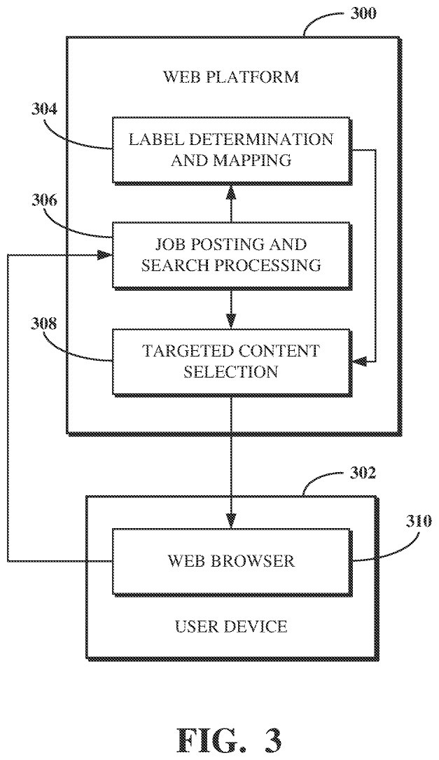

FIG. 3 is a block diagram of an example of a web platform 300 that hosts job postings. The web platform 300, which may, for example, be the web platform 102 shown in FIG. 1, is a job website or a software platform associated with a job posting website. A user of a user device 302, which may, for example, be the user device 110 shown in FIG. 1, may access the web platform 300 to, amongst other things, search for job postings, and may be served with job posting content targeted for delivery to the user device 302. Such functionality of the web platform 300 is provided by way of various software which may, for example, be implemented using the application server 106 shown in FIG. 1. As shown, the software includes or otherwise relate to label determination and mapping software 304, job posting and search processing software 306, and targeted content delivery software 308. The software 304 through 308 includes tools, such as programs, subprograms, functions, routines, subroutines, operations, and/or the like for targeted content delivery within the web platform 300.

The label determination and mapping software 304 determines labels for job postings of a job posting corpus of the web platform 300 and maps those labels to ones of the job postings. The job posting corpus represents an entire collection of job postings hosted by the web platform 300. In some cases, the job posting corpus may include all job postings for which data remains hosted at the web platform 300 (i.e., any job postings for which representative data has not been culled or evicted per a policy). In other cases, the job posting corpus may include all job postings which have been hosted for less than a threshold period (e.g., one year or five years). Data associated with a job posting within the job posting corpus corresponds to one or more of a raw title for the job posting (i.e., a title which was originally provided as input by a user of the web platform 300 who created the job posting), a normalized title for the job posting (i.e., a canonicalized title determined based on a global understanding of job postings within the corpus), a category for the job posting (i.e., an industry, sub-industry, or other sector or professional grouping to which the job posting corresponds), company information (i.e., information associated with a company to hire a successful candidate applying to the job posting), or the like.

The label determination and mapping software 304 determines normalized data for job titles associated with job postings of the job posting corpus and for queries input by users of the web platform 300 over some period of time (e.g., within the past year or since the initiation of the web platform 300) in connection with searches for job postings. In particular, the label determination and mapping software 304 determines normalized job titles and normalized queries. Relatedly, the web platform 300 maintains a knowledge graph used to represent the job posting corpus. The knowledge graph is a collection of triplets in which each triplet corresponds to a head, or first, node; a tail, or second, node; and a relationship between the first and second nodes. The nodes in the knowledge graph correspond to one of a user identifier, a normalized job title, or a normalized query. The relationships between a set of nodes thus indicates a relationship between a user identifier and one of a normalized job title or a normalized query. For example, a relationship can indicate that a normalized query was queried by a user associated with a user identifier. In another example, a relationship can indicate that a normalized job title was applied by a user associated with a user identifier.

The knowledge graph thus only represents job postings that are presently within the job posting corpus of the web platform 300. As such, the knowledge graph contemplates only those job titles which are already represented within the job posting corpus. However, through the continued operation of the web platform 300, the job posting corpus will likely grow to include new job postings in which many may have job titles that do not align closely with the normalized job titles which have been determined for the job posting corpus. To address this, the label determination and mapping software 304 trains a knowledge graph embedding. The knowledge graph embedding is or otherwise includes embedding representations of nodes of the knowledge graph and their corresponding relationship in a knowledge graph across a given dimension, which may be a normalized job title and/or a normalized query. The embeddings of a trained knowledge graph embedding indicate how raw job title or raw query data is mapped to a normalized job title or a normalized query, respectively, whether independently or based on certain web platform user information (e.g., user segments, as will be described below). The trained knowledge graph embedding leverages machine learning to generate labels associated with normalized job titles and/or normalized queries. In particular, and as will be described below, the trained knowledge graph embedding is used to determine labels for job postings both of the job posting corpus of the web platform 300 as well as for job postings received after the training of the knowledge graph embedding. A label for a job posting indicates a user segment to which a normalized job title and/or normalized query associated with the labeled job posting corresponds. The user segment represents some subset of job seeker users of the web platform based on some user criteria (e.g., skill, industry, education, or location). The label determination and mapping software 304 accordingly determines labels and maps those labels to job postings hosted by the web platform 300.

The job posting and search processing software 306 generates and/or publishes job postings for hosting at the web platform 300 based on input obtained from one or more sources. The one or more sources may, for example, include one or more of the user device 302, an intermediary system (e.g., the intermediary system 112 shown in FIG. 1), or an external source (e.g., the external source 114 shown in FIG. 1). Job postings generated and/or published using the job posting and search processing software 306 may then be searched for by job seekers using the web platform 300. For example, queries obtained from devices of job seekers using the web platform 300 (e.g., the user device 302) in connection with searches for job postings may be processed against a job posting corpus of the web platform 300 to identify job postings corresponding to those queries. Content of the resulting job postings may then be served to the user device 302, such as within a graphical user interface of the web platform 300 output for rendering within a web browser 310 running at the user device 302. In some implementations, the graphical user interface which includes the content of the resulting job postings may be output within software other than the web browser 310. For example, where the user device 302 is a mobile device, a mobile application (e.g., a client application connected to functionality of the web platform 300) may be used in place of the web browser 310.

The targeted content selection software 308 selects job postings as targeted content to deliver to user devices, such as the user device 302, based on queries received from those user devices and labels determined by the label determination and mapping software 304. In particular, when a job posting is created at or otherwise for hosting by the web platform 300, the job posting and search processing software 306 provides data associated with the job posting to the label determination and mapping software 304, which uses that data to determine one or more labels for the job posting. When a query related to the job posting (e.g., based on a similarity or other overlap in metadata such as raw job title, category, or company information) is later received from the user device 302, the job posting and search processing software 306 determines labels for the query and uses output from the label determination and mapping software 304 to determine (e.g., based on a match or similarity to the one or more labels determined for the job posting) that the job posting or data associated therewith is to be delivered to the user device 302 as targeted content. The targeted content is then delivered to the user device 302, for example, within the graphical user interface output within the web browser 310 (or other software, as applicable). Accordingly, the targeted content selection 308 selects relevant job postings for a given job seeker using the labels determined using the label determination and mapping software 304 and causes a delivery thereof as targeted content to the user device 302.

Although the software 304 through 308 is shown as separate software of the web platform 300, in some implementations, two or more of the software 304 through 308 may be combined into a single software aspect of the web platform 300. In some implementations, functionality of some or all of the software 304 through 308 may exist outside of the software 304 through 308. As such, in some implementations, the web platform 300 may exclude one or more of the software 304 through 308 while still including the functionality thereof in some form elsewhere or otherwise make use of the functionality of the software 304 through 308 while some or all of such functionality is included in some form elsewhere.

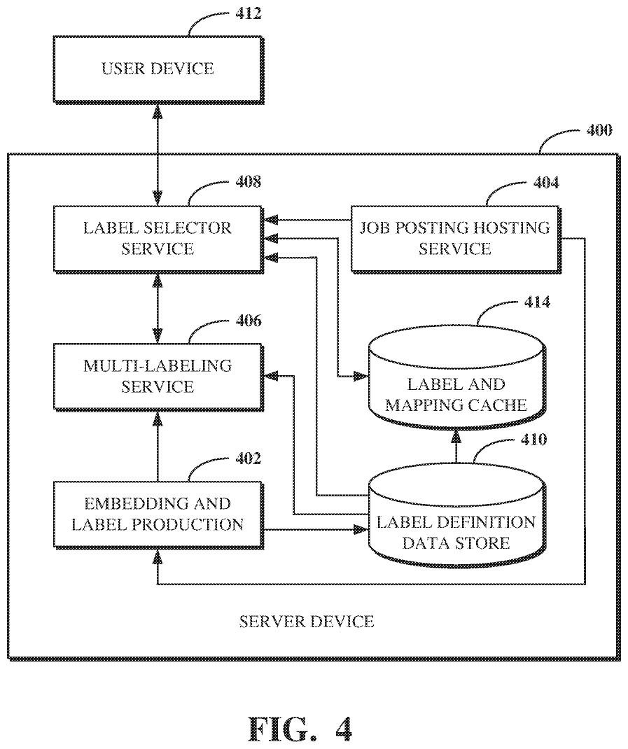

FIG. 4 is a block diagram of an example of a system for targeted content delivery within a web platform, such as the web platform 300. The system includes a server device 400 that implements, executes, interprets, or otherwise runs software used for targeted content delivery within a web platform and hardware used to implement the software. For example, the server device 400 may implement an application server (e.g., the application server 106 shown in FIG. 1) used to implement software of the web platform, such as the software 304 through 308 shown in FIG. 3. In particular, the system of FIG. 4 as shown describes functionality of label determination and mapping software used for targeted content delivery within the web platform, for example, the label determination and mapping software 304. As shown, the server device 400 implements, executes, interprets, or otherwise runs software including or otherwise corresponding to embedding and label production software 402, a job posting hosting service 404, a multi-labeling service 406, and a label selector service 408.

The embedding and label production software 402 trains a knowledge graph embedding based on a knowledge graph of the web platform and determines labels for job postings based on the trained knowledge graph embedding. The embedding and label production software 402 trains the knowledge graph embedding using normalized job data of the web platform. Once a normalized job title is determined, all related raw titles are normalized to that normalized title, regardless of their original formatting and/or any additional information accompanying them. For example, the raw title “Anticipated Middle School Math Teaching Position” may be normalized into the normalized title “Mathematics Teacher.” In another example, the raw title “Senior Java Architect (Java/.Net/Apache)” may be normalized into the normalized title “Senior Software Architect.” In yet another example, the raw title “Hiring HR Mgr” may be normalized into the normalized title “Human Resources Manager.”

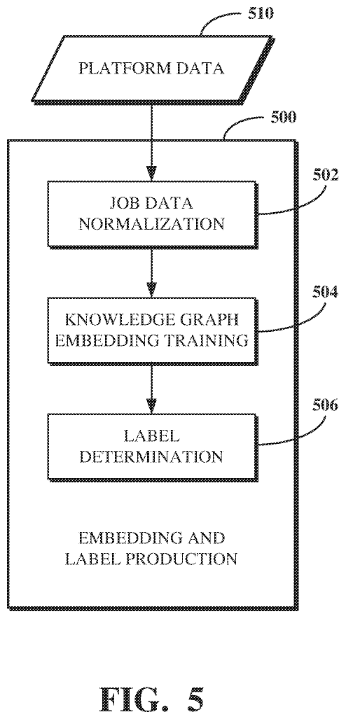

The embedding and label production software 402 obtains job data of the job posting corpus of the web platform from the job posting hosting service 404, which is, includes, or otherwise refers to software used by the web platform to host job postings. For example, the embedding and label production software 402 may retrieve (i.e., by a push or pull mechanism) current and/or historical job data for the web platform from the job posting hosting service 404. Implementations and examples for training the knowledge graph embedding based on the normalized job data of the web platform and for determining labels available for job postings using the trained knowledge graph embedding are described below with respect to FIG. 5. Data indicative of the labels determined for various job posting data using the trained knowledge graph embedding, and which thus are composed of the normalized job titles and normalized queries, are then stored within a label definition data store 410 for future use in targeted content delivery within the web platform. For example, the label definition data store 410 may be created based on a first training of the knowledge graph embedding and updated based on subsequent updates (e.g., re-trainings) of the knowledge graph embedding. In some cases, data stored in the label definition data store 410 and representative of a label may be culled from the label definition data store 410, for example, based on a determination that the data corresponds to a job title which is no longer represented within the job posting corpus of the web platform. The label definition data store 410 may, for example, be implemented by a NoSQL database program, such as MongoDB.

The multi-labeling service 406 is, includes, or otherwise refers to software that uses the trained knowledge graph embedding produced by the embedding and label production software 402 (e.g., trained offline) to determine labels for select job postings. Determining labels for a job posting includes determining one or more labels which should be associated with the job posting based, for example, on a relevance of the job posting to content of the one or more labels. For example, determining labels for a job posting can include mapping one or more labels to the job posting, or otherwise generating data indicative of such a mapping, to indicate an association between the job posting and the one or more labels.

To determine one or more labels for a job posting, the multi-labeling service 406 accesses the label definition data store 410 to retrieve (i.e., using a push or pull mechanism) some or all of the labels determined using the trained knowledge graph embedding. The multi-labeling service 406 arranges the retrieved labels into one or more vectors, and the vectors may then be indexed to associate ones of the labels with one or more entity types that are representative of label categories. For example, there may be two entity types in which one is an entity title which refers to labels corresponding to normalized job titles and the other is an entity query which refers to labels corresponding to normalized queries. In another example, there may be three entity types in which one is an entity resume title which refers to the normalized job title that appears in a resume of a job seeker, another is an entity clicked title which refers to the normalized job title that a job seeker has recently interacted with (e.g., by clicking on a job posting to view information associated therewith, such as within results of a search), and the third is an entity recent query which refers to the normalized query that a job seeker entered to search for job postings. In particular, to arrange the labels into vectors, the multi-labeling service 406 performs mean-pooling over the data stored in the label definition datastore 410, in which the labels are put into the vectors as the output of the mean-pooling process. Thereafter, the vectors are indexed with an identifier by the a Non-Metric Space Library (NMSLIB), for example, using a k-nearest neighbor search (e.g., an approximate nearest neighbor (ANN) search) in which k=1, to determine which labels within the vectors correspond to which indices (e.g., ones of an entity resume title, an entity clicked title, and an entity recent query). While vectors are described herein by example, in some implementations, other types of data structures may be used instead of vectors.

When a job posting is input into the multi-labeling service 406, the indices are called to obtain labels from the label definition data store 410, and lists of scores are then generated based on the labels. The lists of scores represent scores of labels which correspond to a subject index, in which each list of scores corresponds to a single index. The lists of scores are integrated to determine a list of labels to use for job postings to deliver as targeted content. In particular, the multi-labeling service 406 takes information (e.g., metadata) associated with a job posting, such as one or more of the raw job posting title, the normalized job posting title, a category, company information, or the like, as input and produces a list of recommended labels for the job posting as output. The multi-labeling service 406 begins by ensuring that the input includes a normalized title. For example, if the field of the normalized job title in the input is empty (e.g., due to a title not being listed in the job posting), the normalized job title for the job posting is set to a most plausible normalized job title from the universe of normalized job titles determined for the corpus of job postings of the web platform. The multi-labeling service 406 then determines similarity scores (e.g., using a cosine similarity metric with a NMSLIB) for the indices to which the labels correspond (e.g., an entity resume title, an entity clicked title, or an entity recent query). If the similarity score for a given index meets a threshold, the score is added to a list of recommended labels for the job posting. Once all indices in all vectors have been evaluated, the list of recommended labels is sorted by score (e.g., in descending order) and output.

In some cases, the job title for a job posting input into the multi-labeling service 406 and used to determine a list of recommended labels for the job posting may not correspond to a normalized job title determined for the corpus of job postings. For example, the trained knowledge graph embedding may not yet recognize titles such as the one used in the job posting. In such a case, a transformer-based machine learning technique for natural language processing may be used (e.g., by the multi-labeling service 406) to identify the missing normalized job title to use for the job posting. For example, the transformer-based machine learning technique for natural language processing may be or otherwise utilize one or more of BERT, ROBERTa, DistilBERT, ALBERT, or XLNet. Using the transformer-based machine learning technique for natural language processing, a new normalized job title may be determined for the job posting. For example, an N-dimension word embedding may be generated using the transformer-based machine learning technique for natural language processing with a dense machine learning layer before calling indices to retrieve labels from the label definition data store 410.

In some cases, a normalized job title may be too broad to ensure that content labeled in association therewith is relevant to a given job seeker. For example, a normalized job title may be “technician,” in which the raw titles processed to determine that normalized job title include “HVAC technician,” “electrician,” “field technician.” “maintenance professional,” “mechanic.” “service technician,” and so on. To ensure that content is appropriately labeled for such broad normalized job titles, a string matching library may be used (e.g., by the multi-labeling service 406) to evaluate labels that have a score which exceeds a second threshold which is higher than the default threshold used for the similarity scoring. For example, the string matching library may be the RapidFuzz Python library.

The label selector service 408 automatically selects labels for an incoming job posting. The label selector service 408 receives information associated with a new job posting created at or otherwise hosted by the job posting hosting service 404 from a user device 412, which may, for example, be the user device 110 shown in FIG. 1. In particular, the label selector service 408 receives an indication of a new job posting created based on input received from the user device 412, in which the user device 412 is a device of a user who is causing the job posting to be published for job seeker access at the web platform. For example, the indication may refer to a completion of a process for creating a job posting. In such a case, the label selector service 408 determines one or more labels for the job posting based on the received indication. In some such cases, the indication may be received from the job posting hosting service 404 in addition to or instead of the user device 412. Alternatively, the label selector service 408 may receive a request to label a new job posting created based on input received from the user device 412. For example, the request may be transmitted as part of the process for creating the job posting. In such a case, the label selector service 408 determines one or more labels for the job posting based on the received request. In some implementations, however, the user device 412 may indicate a list or batch of job postings for the label selector service 408 to determine labels for, in which case the label selector service 408 may operate to determine one or more labels for each such job posting. In such a case, the list or batch of job postings may be received in response to a creation of a final one of the job postings or other than based on a process for creating a job posting. For example, the list or batch of job postings may be received from the user device 412 sometime after each job posting in the list or batch of job postings has been created.

In particular, label data representative of labels determined using the multi-labeling service 406 and stored in the label definition data store 410 may be loaded into a label and mapping cache 414 from the label definition data store 410. The label and mapping cache 414 is or includes a cache (e.g., within a memory of the server device 400 or within a virtual memory accessible by the server device 400) for storing data indicative of labels determined by the multi-labeling service 406 and mappings between ones of those labels and user segments of the web platform. Thereafter, the label selector service 408 maintains a background process that listens to a change stream of the label definition data store 410 (i.e., data indicative of changes pushed thereto) and uses data obtained by listing to the change stream to determine to update the label and mapping cache 414. When the label selector service 408 receives an indication or a request to determine one or more labels for a job posting, the label selector service 408 searches the label and mapping cache 414 for the one or more labels to use for the job posting and transmits, to the user device 412, an indication of those one or more labels in some form. In the event of a cache miss, such as due to relevant labels for the incoming job posting for which the indication or request is received not being present in the label and mapping cache 414, the label selector service 408 retrieves metadata associated with the job posting from the job posting hosting service 404, calls the multi-labeling service 406 to cause the multi-labeling service 406 to determine labels based on that metadata, receives new label data indicative of labels determined by the multi-labeling service 406 based on the metadata, and then stores the new label data within the label and mapping cache 414. In some implementations, the label and mapping cache 414 may be updated based on an offline batch process.

While the software 402 through 408 is shown as being implemented, executed, interpreted, or otherwise run at and the label definition data store 410 or the label and mapping cache 414 are shown as being implemented or otherwise maintained at the server device 400, in some implementations, multiple server devices such as the server device 400 may be used by the system for targeted content delivery within the web platform. For example, a first server device may implement, execute, interpret, or otherwise run the software 402 through 408 while a second server device may implement or otherwise maintain the label definition data store 410 or the label and mapping cache 414.

FIG. 5 is a block diagram of an example of embedding and label production functionality of a system for targeted content delivery within a web platform, for example, the system shown in FIG. 4. The embedding and label production functionality is described with respect to embedding and label production software 500, which may, for example, be the embedding and label production software 402 shown in FIG. 4. As shown, the embedding and label production software 500 includes a job data normalization tool 502, a knowledge graph embedding training tool 504, a label determination tool 506, and a segment mapping tool 508.

The job data normalization tool 502 performs normalization against platform data 510 representative of a job posting corpus. The normalized title for a given job posting is determined as the best (e.g., most representative or accurate) title for the job posting from among a group of titles that are synonymous, alternatives, or interchangeable. The normalized query is determined as the best (e.g., most representative or accurate) query for searching for the job posting from among a group of queries that are synonymous, alternatives, or interchangeable. Examples may follow those of the normalized titles.

The knowledge graph embedding training tool 504 trains a knowledge graph embedding based on the normalized job data output by the job data normalization tool 502. The knowledge graph embedding may be trained over select nodes and their corresponding relationship using a model for inferring patterns in relationships between nodes. One example of a pattern inference model which may be used for training a knowledge graph embedding is RotatE, developed by Z. Sun et al, which operates based on the principal of Euler's identity that a unitary complex number can be regarded as a rotation in a complex plane to define a relationship between a head node and a tail node within a knowledge graph as a rotation from the head node to the tail node in a complex vector space. A pattern inference model may, for example, infer relationship patterns between knowledge graph nodes based on modeled qualities such as symmetry (or antisymmetry, as applicable), inversion, and/or composition. Thus, the input to a pattern inference model may be one or more triplets of a knowledge graph and the output of the pattern inference model may be a knowledge graph embedding.

The label determination tool 506 uses the trained knowledge graph embedding is to determine labels for job posting data of the web platform, and, specifically, for the normalized job titles and normalized queries. In particular, the trained knowledge graph embedding is used to recursively iterate through job titles and queries to determine labels for the job posting data of the web platform. For example, the recursive iteration may begin with the identification of a head node that corresponds to a user identifier for a given triplet. From the tail node of that triplet, which either corresponds to a normalized job title or a normalized query, other similar (or alternative or interchangeable) job titles or queries are recursively identified using a similarity score, representing a measure of a quality of a given label for the normalized job title or normalized query to which that tail node correspond. For example, the similarity score may be computed using NMSLIB that explores the ANN for relevant labels. In one particular example, the NMSLIB may be or otherwise use a cosine similarity metric to determine the similarity score for the subject tail node. The recursive iteration for determining the similarity score may continue until the similarity score reaches a threshold. As such, a label may be determined for select job posting data (i.e., a normalized job title or normalized query) based on the similarity score meeting the threshold.

The trained knowledge graph embedding may in some cases be updated (e.g., re-trained), such as to address changes to the corpus of job postings of the web platform. For example, the trained knowledge graph embedding may be periodically updated, such as on a discrete time interval (e.g., once per week or once per month). In another example, the trained knowledge graph embedding may be updated other than on a periodic basis, such as based on an event (e.g., a threshold number of job postings being added to or removed from the corpus of job postings of the web platform).

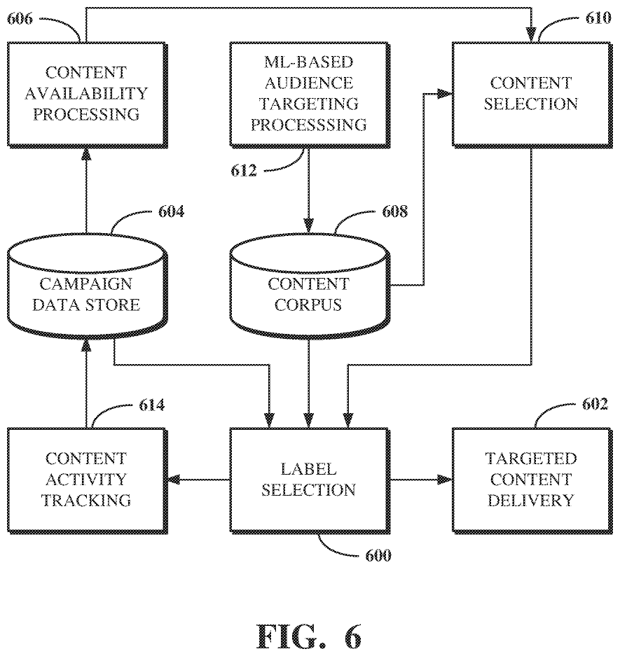

FIG. 6 is a block diagram of an example of label selection functionality of a system for targeted content delivery within a web platform, for example, the system shown in FIG. 4. The label selection functionality is described with respect to label selection software 600, which may, for example, be software used by the label selection service 408 shown in FIG. 4. In particular, the label selection software 600 selects a label for targeted content to deliver using targeted content delivery software 602, for example, the targeted content delivery software 308 shown in FIG. 3. The label selection software 600

The label selection software 600 is used with an automatic targeting process in which targeting criteria are set up automatically for web platform users whose content (i.e., job postings) will be delivered as targeted content using the targeted content delivery software 308. Such a web platform user may initiate a campaign for the delivery of their targeted content using such an automatic targeting process, in which the web platform determines segments of job seeker users to whom to deliver the targeted content and automates the delivery thereof according to the targeting criteria set for the campaign. In this way, rather than require such users to pre-select segments of the web platform users to whom to deliver the targeted content, the identification of such web platform users is automated based on the labels selected using the label selection software 600.

The automatic targeting pipeline uses information stored within a campaign data store 604, which is data store (e.g., a relational database, such as a SQL database) that stores information associated with a company for which job postings will be delivered as targeted content via the campaign, the job postings themselves, interactions by job seekers with delivered ones of the job postings, and the like. Data of the campaign data store 604 is retrieved by a content availability processing service 606, which identifies resource availability (e.g., budgetary constraints) for controlling further content selection from a content corpus 608 that stores the job posting information to be delivered by the targeted content delivery software 602. For example, the content corpus 608 may represent a portion of content records hosted by a service of the web platform (e.g., the job posting hosting service 404 shown in FIG. 4). Based on a determination by the content availability processing service 606 that resources are available for certain job posting content, content selection software 610 selects the job posting for targeted content delivery from the content corpus 608.

The content corpus 608 is updated or otherwise maintained by the company for which the targeted content will be delivered to job seeker users of the web platform. However, machine learning-based audience targeting processing software 612 may also be used to update or otherwise maintain the job posting data stored within the content corpus 608. For example, the machine learning-based audience targeting processing software 612 may perform operations for extracting information from context records of the system (e.g., records usable for geo-targeting, channel targeting, or contextual targeting), user records of the system (e.g., records usable for demographic targeting or behavioral targeting), and/or data of the targeted content itself. Some or all of the extracted information may derive from a multi-labeling service of the system (e.g., the multi-labeling service 406 shown in FIG. 4).

The label selection software 600 obtains indications of the content to serve from the content selection software 610 and uses such indications to retrieve corresponding job posting data from the content corpus 608. The label selection software 600 then performs user segment matching to ensure that relevant ones of the job postings from the content corpus 608 are delivered as targeted content to appropriate job seeker users of the web platform. In particular, to perform the user segment matching, the label selection software 600 uses fields associated with entities used to index labels by the multi-labeling service (e.g., an entity recent query, an entity resume title, and an entity clicked title) classify users into user segments. This can be done either via a separate online service or an offline batch job. The label selector service maps ones of the job postings selected by the content selection software 610 and labels determined for the job postings represented in the content corpus 608.

Upon a determination that a job seeker user matching the subject user segment has presented a query to search for job postings at or otherwise with the web platform, the targeted content delivery software 602 causes a delivery of the relevant targeted content to that user based on their user segment. Content activity tracking software 614 receives an indication of the job postings which are delivered as targeted content and maintains records indicative of deliveries of such content and interactions with such content by the job seeker users to whom the content is delivered. Output of the content activity tracking software 614 may later be used to update records of the campaign data store 604, such as to indicate further resources for such content or to cause a culling of such content from the campaign.

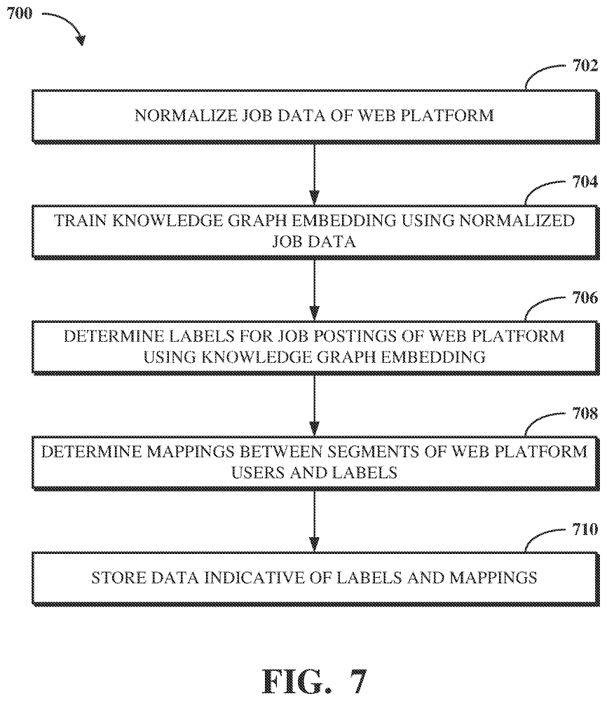

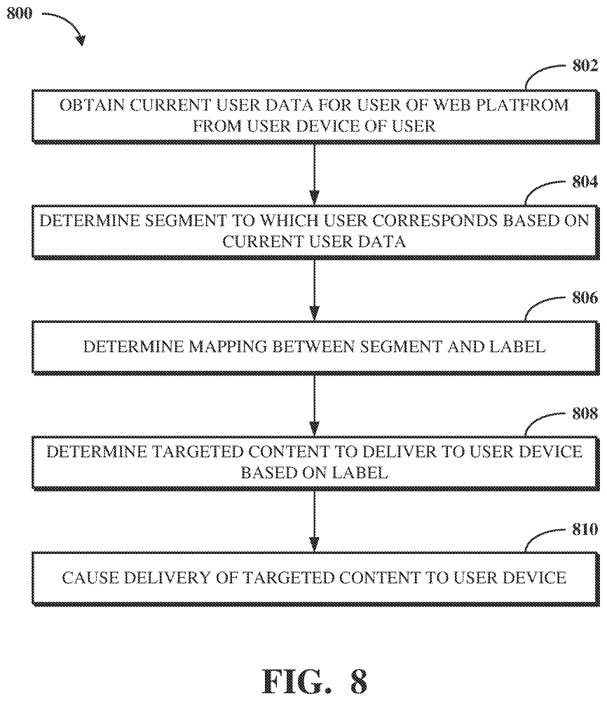

To further describe some implementations in greater detail, reference is next made to examples of techniques which may be performed by or using a system for targeted content delivery within a web platform and/or for mapping content of a web platform to labels for targeted content delivery. FIG. 7 is a flowchart of an example of a technique 700 for mapping content of a web platform to labels for targeted content delivery. FIG. 8 is a flowchart of an example of a technique 800 for targeted content delivery within a web platform.

The technique 700 and/or the technique 800 can be executed using computing devices, such as the systems, hardware, and software described with respect to FIGS. 1-6. The technique 700 and/or the technique 800 can be performed, for example, by executing a machine-readable program or other computer-executable instructions, such as routines, instructions, programs, or other code. The steps, or operations, of the technique 700 and/or the technique 800 or another technique, method, process, or algorithm described in connection with the implementations disclosed herein can be implemented directly in hardware, firmware, software executed by hardware, circuitry, or a combination thereof.

For simplicity of explanation, the technique 700 and the technique 800 are each depicted and described herein as a series of steps or operations. However, the steps or operations in accordance with this disclosure can occur in various orders and/or concurrently. Additionally, other steps or operations not presented and described herein may be used. Furthermore, not all illustrated steps or operations may be required to implement a technique in accordance with the disclosed subject matter.

Referring first to FIG. 7, the technique 700 for mapping content of a web platform to labels for targeted content delivery is shown. At 702, job data of a web platform is normalized. The job data is historical job posting data obtained from a job posting corpus of the web platform, which may, for example, include data of thousands or millions of job postings. The job data is normalized to produce normalized job title data and normalized query data.

At 704, a knowledge graph embedding is trained using the normalized job data. In particular, the knowledge graph embedding is trained to identify relationships between segments of users of the web platform and nodes representative of portions of one or both of the normalized job title data and the normalized query data within a knowledge graph of the web platform. The knowledge graph embedding is trained using unsupervised learning. In some cases, however, the knowledge graph embedding may be trained using supervised learning.

At 706, labels are determined for job postings of the job posting corpus of the web platform using the knowledge graph embedding. In particular, the labels are determined for the historical job posting data of the web platform based on the relationships identified using the trained knowledge graph embedding. Determining the labels for the historical job posting data includes performing a recursive search against the normalized job title data and the normalized query data using the trained knowledge graph embedding to determine the labels. For example, the labels may be determined by recursively searching through the normalized job data using the knowledge graph embedding until a score threshold is met.

At 708, mappings are determined between segments of users of the web platform and ones of the labels. The mappings are determined using a multi-labeling service of the web platform, which accesses a data store within which the labels are stored following their determination using the trained knowledge graph embedding and includes the labels in one or more vectors. The multi-labeling service indexes the one or more vectors according to one or more entity types used to determine the segments. For example, the one or more entity types may correspond to normalized titles within resumes of the users, normalized titles for job postings interacted with by the users within the web platform, and normalized queries searched for by the users. Determining the labels thus includes using a non-metric space library to process output of an approximate next neighbor search against indices of the one or more vectors to determine a list of recommended labels for a job posting of the historical job posting data. For example, the determining can include determining that one or more of the labels correspond to a job posting by scoring indexed vectors corresponding to the labels against the labels using a k-nearest neighbor search.

In one particular example, the web platform includes a multi-labeling service and a label selector service, in which the multi-labeling service determines the labels and stores data representative of the labels within a data store, and the label selector service accesses a cache that stores at least some of the data from the data store to determine that the segment is associated with a given label. Thus, the multi-labeling service uses the output of the trained knowledge graph embedding to build a nearest neighbor index for each segment of users of the web platform. The label selector service then queries an index based on job contents metadata to output a list of segments associated with a label along with a similarity score therefor. In some implementations, contents of the cache may be refreshed based on one or both of an update to the trained knowledge graph embedding or a cache miss. The segments may be based on user interactions with one or more pages of the web platform. For example, the segments may be determined based on user behaviors (e.g., searches performed and/or job postings interacted with by job seeker users of the web platform) captured within the web platform.

In some cases, the mappings may be represented as the indexed vectors of the labels, as described above. Determining the mapping for a given job posting, such as a job posting of the job posting corpus that existed prior to the training of the knowledge graph embedding or a new job posting created after the training of the knowledge graph embedding, may thus include obtaining job posting data for the job posting, processing the job posting data against the indexed vectors using a non-metric spatial library to determine scores for ones of the labels, and determining, based on the scores, a list of recommended labels for the job posting data, in which the list of recommended labels indicates a mapping between the job posting and one or more segments of the segments of users of the web platform.

At 710, data indicative of the labels and mappings are stored for later use with the web platform. The labels and mappings will be used in connection with the selection of targeted content for delivery to a user device of a user of the web platform in response to a query for job postings received at the web platform from the user device.

In some implementations, the trained knowledge graph embedding may be updated according to updates to the job posting corpus of the web platform. In some such implementations, a data store storing data representative of the labels may be updated based on the updates to the trained knowledge graph embedding.

Referring next to FIG. 8, the technique 800 for targeted content delivery within a web platform is shown. At 802, current user data is obtained for a user of a web platform from a user device of the user. The current user data is data associated with a query received from the user device, for example, as part of a search by the user for job postings hosted by the web platform. In some cases, metadata associated with the current user data may be obtained by accessing a hosting service of the web platform. For example, the hosting service may host a resume uploaded to the web platform by the user, in which case the metadata may represent user information including one or more of work experience, industry relevance, skill sets, languages, locations, or the like of the user.

At 804, a segment to which the user corresponds is determined based on the current user data. The segment is identified based on a correspondence between the current user data and one or both of normalized job data of the job posting corpus of the web platform or data associated with an entity type used to determine labels for the normalized job data.

At 806, a mapping is determined between the segment to which the user corresponds and a label for job data of the web platform. Determining the mapping can include evaluating targeting criteria defined for various targeted content available for delivery to users of the web platform, such as via one or more content campaigns.

At 808, targeted content to deliver to the user device is determined based on the label. The targeted content is, includes, or otherwise refers to a job posting hosted by the web platform. For example, the targeted content may indicate a sponsored job posting of the web platform. The targeted content may be determined based on the label using a stored mapping between the label and the targeted content. For example, the mapping may be determined as part of a process for determining the labels for the job posting of the targeted content when the job posting is created at or otherwise made available for hosting by the web platform.

At 810, a delivery of the targeted content to the user device is caused. For example, causing the targeted content delivery can include a service of the web platform or otherwise used by the web platform retrieving the data associated with the targeted content from a content corpus and transmitting that data for rendering at the user device, for example, within a graphical user interface within which search results based on the current user data query are output.

The implementations of this disclosure can be described in terms of functional block components and various processing operations. Such functional block components can be realized by a number of hardware or software components that perform the specified functions. For example, the disclosed implementations can employ various integrated circuit components (e.g., memory elements, processing elements, logic elements, look-up tables, and the like), which can carry out a variety of functions under the control of one or more microprocessors or other control devices. Similarly, where the elements of the disclosed implementations are implemented using software programming or software elements, the systems and techniques can be implemented with a programming or scripting language, such as C, C++, Java, JavaScript, Python, assembler, or the like, with the various algorithms being implemented with a combination of data structures, objects, processes, routines, or other programming elements.

Functional aspects can be implemented in algorithms that execute on one or more processors. Furthermore, the implementations of the systems and techniques disclosed herein could employ a number of conventional techniques for electronics configuration, signal processing or control, data processing, and the like. The words “component” and “aspect” are used broadly and are not limited to mechanical or physical implementations, but can include software routines in conjunction with processors, etc. Likewise, the terms “system” or “tool” as used herein and in the figures, but in any event based on their context, may be understood as corresponding to a functional unit implemented using software, hardware (e.g., an integrated circuit, such as an application-specific integrated circuit (ASIC)), or a combination of software and hardware. In certain contexts, such systems or mechanisms may be understood to be a processor-implemented software system or processor-implemented software mechanism that is part of or callable by an executable program, which may itself be wholly or partly composed of such linked systems or mechanisms.

Implementations or portions of implementations of this disclosure can take the form of a computer program product accessible from, for example, a computer-usable or computer-readable medium. A computer-usable or computer-readable medium can be a device that can, for example, tangibly contain, store, communicate, or transport a program or data structure for use by or in connection with a processor. The medium can be, for example, an electronic, magnetic, optical, electromagnetic, or semiconductor device.

Other suitable mediums are also available. Such computer-usable or computer-readable media can be referred to as non-transitory memory or media, and can include volatile memory or non-volatile memory that can change over time. A memory of an apparatus described herein, unless otherwise specified, does not have to be physically contained by the apparatus, but is one that can be accessed remotely by the apparatus, and does not have to be contiguous with other memory that might be physically contained by the apparatus.

While the disclosure has been described in connection with certain implementations, it is to be understood that the disclosure is not to be limited to the disclosed implementations but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A method for targeted content delivery within a web platform, the method comprising:
normalizing historical job posting data of the web platform to produce normalized job title data and normalized query data;
training, using unsupervised learning, a knowledge graph embedding to identify relationships between segments of users of the web platform and nodes representative of portions of one or both of the normalized job title data and the normalized query data within a knowledge graph of the web platform;
determining labels for the historical job posting data of the web platform based on the relationships identified using the trained knowledge graph embedding;
obtaining a query from a user device of a user of the web platform;
determining a segment of the segments to which the user corresponds based on the query;
determining that the segment is associated with a label of the labels;
determining targeted content to deliver to the user device in response to the query based on the label; and
causing a delivery of the targeted content to the user device.

2. The method of claim 1, wherein determining the labels for the historical job posting data comprises:
performing a recursive search against the normalized job title data and the normalized query data using the trained knowledge graph embedding to determine the labels.

3. The method of claim 2, wherein the web platform includes a multi-labeling service and a label selector service,
wherein the multi-labeling service determines the labels and stores data representative of the labels within a data store, and
wherein the label selector service accesses a cache that stores at least some of the data from the data store to determine that the segment is associated with the label.

4. The method of claim 3, wherein contents of the cache are refreshed based on one or both of an update to the trained knowledge graph embedding or a cache miss.

5. The method of claim 3, wherein the multi-labeling service stores the labels within one or more vectors and indexes the one or more vectors according to one or more entity types used to determine the segments.

6. The method of claim 5, wherein the one or more entity types correspond to normalized titles within resumes of the users, normalized titles for job postings interacted with by the users within the web platform, and normalized queries searched for by the users.

7. The method of claim 5, wherein determining the labels for the historical job posting data comprises:
using a non-metric space library to process output of an approximate next neighbor search against indices of the one or more vectors to determine a list of recommended labels for a job posting of the historical job posting data.

8. The method of claim 1, wherein the segments are based on user interactions with one or more pages of the web platform.

9. A method for targeted content delivery within a web platform, the method comprising:
determining, using a knowledge graph embedding trained using normalized job data of the web platform, mappings between segments of users of the web platform and labels for the normalized job data;
obtaining current user data for a user of the web platform from a user device of the user;
determining, based on the current user data, a current segment of the segments to which the user corresponds;
determining, according to a current mapping of the mappings, a current label of the labels to which the current segment corresponds; and
causing a delivery of targeted content associated with the current label to the user device.

10. The method of claim 9, wherein the mappings are indexed vectors of the labels, and wherein determining the mappings comprises:
obtaining new job posting data for a new job posting hosted by the web platform;
processing the new job posting data against the indexed vectors using a non-metric spatial library to determine scores for ones of the labels; and
determining, based on the scores, a list of recommended labels for the new job posting data, the list of recommended labels indicating a mapping between the new job posting and one or more segments of the segments.

11. The method of claim 9, comprising:
determining the labels by recursively searching through the normalized job data using the knowledge graph embedding until a score threshold is met.

12. The method of claim 11, wherein the mappings are determined using a first service of the web platform that accesses the labels determined using the knowledge graph embedding within a data store, and wherein data representative of the labels is populated within a cache accessible by a second service of the web platform to enable the second service to determine the current label.

13. The method of claim 9, wherein the targeted content indicates a sponsored job posting of the web platform.

14. A method for targeted content delivery within a web platform, the method comprising:
training a knowledge graph embedding to identify relationships between items of normalized job data of the web platform across one or more dimensions;
determining mappings between segments of users of the web platform and labels for job posting data of the web platform using the trained knowledge graph embedding;
determining, based on current user data for a user of the web platform obtained from a user device of the user, a label of the labels using a mapping of the mappings between the label and a segment of the segments; and
causing a delivery of targeted content associated with the label to the user device.

15. The method of claim 14, wherein the one or more dimensions correspond to normalized job titles and normalized queries.

16. The method of claim 14, comprising:
updating the trained knowledge graph embedding according to updates to a job posting corpus of the web platform; and
updating a label definition data store storing data representative of the labels based on the updates to the trained knowledge graph embedding.

17. The method of claim 14, comprising:
determining the segments based on user behaviors captured within the web platform.

18. The method of claim 14, comprising:
determining that one or more of the labels correspond to a job posting by scoring indexed vectors corresponding to the labels against the labels using a k-nearest neighbor search.

19. The method of claim 14, wherein determining the label comprises:
accessing a hosting service of the web platform to obtain metadata associated with the current user data.

20. The method of claim 14, wherein the trained knowledge graph embedding is trained using unsupervised learning.
